(19) United States
(12) Patent Application Publication
(10) Pub. No.: US 2005/0138538 A1
(43) Pub. Date: Jun. 23, 2005

(54) Method and system for abstracting electronic documents

(76) Inventor: Domenico Raguseo, Rome (IT)

Correspondence Address: IBM CORPORATION;INTELLECTUAL PROPERTY LAW, 11400 BURNET ROAD, AUSTIN, TX, 78758, US

(21) Appl. No.: 10/892,435

(22) Filed: Jul. 15, 2004

(30) Foreign Application Priority Data
Dec. 19, 2003 (EP) 03368119.8

(51) Int. Cl. G06F 15/00

(52) U.S. Cl. 715/500

(57) ABSTRACT

A method (300) and a corresponding system are proposed for facilitating the process of learning on-line documents. In the method of the invention, a reader directly selects (310-314) the relevant portions of the document. For each selected portion, a question with a corresponding correct answer is generated automatically (316-322). The reader is then prompted to enter (324-326) a personal answer to each question. The personal answer is compared (328) with the corresponding correct answer, in order to determine a score indicative of a level of understanding. For each score that is unsatisfactory, the corresponding selected portion is expanded (330-332) by adding a sentence of the document directly preceding the selected portion. In this way, the abstract is refined with an interactive process mixing human knowledge and automatic processing.

### TECHNICAL FIELD

The present invention relates to the information storage field, and more specifically to a method and a corresponding system for abstracting electronic documents.

### BACKGROUND ART

The management of electronic documents (i.e., documents in a computer readable form) is a critical issue in modern data processing systems. Particularly, a problem arises when a large amount of information must be managed; a typical example is that of a distributed organization, wherein a huge number of electronic documents are routinely generated, archived, retrieved and transmitted. The problem has been further exacerbated by the widespread diffusion of the Internet, since a potential infinite number of users can download any kind of information from remote servers; however, this causes a substantial overload of an infrastructure implementing the Internet, with a corresponding degradation of its overall performance.

Several solutions have been proposed in the last years in an attempt to solve the above-mentioned problems. For example, different algorithms are known in the art for automatically generating an abstract of a document (under the control of a corresponding program running on a computer); in this way, it is possible to reduce the amount of information that must be managed (i.e., stored and transmitted).

A drawback of all the programs currently available is the poor quality of the abstract that is generated (especially when the processed document is based on a very specialized language). In other words, the abstract is unable to convey the actual informative content of the corresponding original document.

In any case, the abstract generated by the program is totally impersonal for its own nature (being the result of a pure algorithm); therefore, the abstract cannot meet the specific requirements of different readers.

Moreover, this approach is unsuitable to assist the reader in a process of learning and memorizing the content of the document.

### SUMMARY OF THE INVENTION

It is an object of the present invention to provide a method of abstracting electronic documents, which combines the advantages of an automatic procedure with those of a human intervention.

Particularly, it is an object of the present invention to allow some sort of interaction between the user and the computer during the creation of the abstract.

It is another object of the present invention to facilitate the creation of the abstract of any document by the reader.

It is yet another object of the present invention to ensure a high quality of the abstract irrespective of the kind of document.

Moreover, it is an object of the present invention to allow any reader to create an abstract that meets his/her personal requirements.

It is another object of the present invention to assist the reader in the process of learning and memorizing the content of the document.

The accomplishment of these and other related objects is achieved by a method of abstracting an electronic document stored on a data processing system, the method including the steps of: selecting at least one portion of the document, generating at least one question with a corresponding correct answer relating to a content of the document, entering a personal answer to each question, comparing each personal answer with the corresponding correct answer, updating the at least one selected portion according to a result of the comparison, and storing an indication of the at least one updated selected portion.

The present invention also provides a computer program for performing the method and a product storing the program. Moreover, a corresponding system for abstracting electronic documents is also encompassed.

The novel features believed to be characteristic of this invention are set forth in the appended claims. The invention itself, however, as well as these and other related objects and advantages thereof, will be best understood by reference to the following detailed description to be read in conjunction with the accompanying drawings.

### BRIEF DESCRIPTION OF THE DRAWINGS

FIG. 1a is a pictorial representation of a computer on which the method of the invention is applicable;

FIG. 2 depicts the main software components used for implementing the method; and

FIGS. 3a-3b show a flow chart describing the logic of the method.

### DETAILED DESCRIPTION OF THE PREFERRED EMBODIMENT(S)

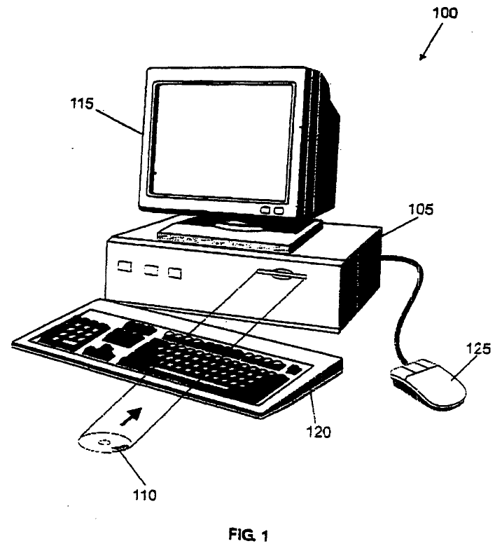

With reference in particular to FIG. 1, a Personal Computer (PC) 100 is shown. The computer 100 consists of a central unit 105, which houses the electronic circuits controlling its operation (such as a microprocessor and a working memory), in addition to a hard-disk and a driver for reading CD-ROMs 110. Output information is displayed on a monitor 115 (connected to the central unit 105 in a conventional manner). The computer 100 further includes a keyboard 120 and a mouse 125, which are used to input information and/or commands.

Similar considerations apply if the computer has a different architecture, or if the computer includes equivalent units (such as other pointing devices and/or input devices); however, the solution of the invention is also suitable to be used on a laptop, a network of computers, or more generally on any other data processing system.

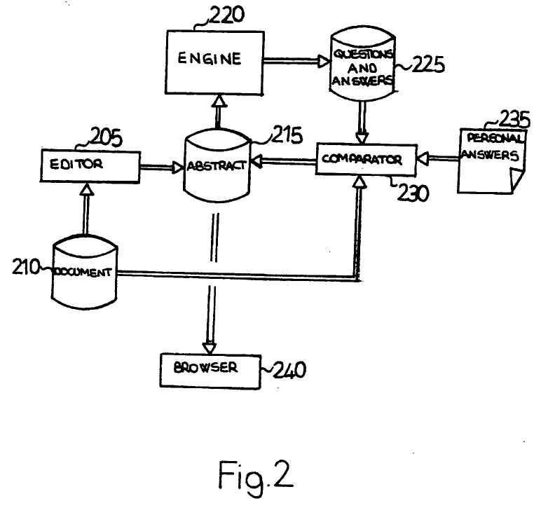

Considering now FIG. 2, the main software components that can be used to practice the method of the invention are depicted. The information (programs and data) is typically stored on the hard-disk and loaded (at least partially) into the working memory when the programs are running, together with an operating system and other application programs (not shown in the figure). The programs are initially installed onto the hard disk from CD-ROM.

Particularly, a user of the computer exploits an editor 205 to update different documents 210; typically, the documents 210 consist of large publications including text, figures, tables or any other information. The editor 205 allows the user to abstract a current document 210 by selecting one or more relevant portions. For each document 210, the editor 205 stores the resulting abstract into a suitable memory structure 215. The abstract 215 consists of the selected portions of the document 210; for each portion, the abstract 215 further includes a pointer to the corresponding location in the original document 210.

An engine 220 accesses the abstract 215. For each selected portion in the abstract 215, the engine 220 generates one or more questions with corresponding correct answers (as described in detail in the following). The questions and answers for the abstract 215 are stored into a corresponding repository 225.

A comparator 230 accesses the question and answer repository 225; moreover, the comparator 230 receives corresponding personal answers 235 entered by the user (in response to the same questions). The comparator 230 updates the abstract 215 according to a result of the comparison between the correct answers (extracted from the repository 225) and the corresponding personal answers 235. For this purpose, the comparator 230 also accesses the original document 210.

A browser 240 is then used to display the abstract 215. The user can also download the abstract 215 to a different device (such as a palmtop); moreover, it is possible to make the abstract 215 available on-line to other computers in a network.

Similar considerations apply if the programs and the corresponding data are structured in another way, if different modules or functions are provided, or if the programs are distributed on any other computer readable medium (such as a DVD). However, the concepts of the present invention are also applicable when equivalent information representing the abstract is stored. For example, in a different embodiment of the invention each selected portion is identified only by a pair of pointers (denoting a starting point and an ending point of the selected portion in the document), or by a pointer and a counter (denoting the starting point and the length of the selected portion, respectively); alternatively, the document is updated to include specific tags surrounding each selected portion. However, the solution according to the present invention is also suitable to be used in applications wherein no distinct abstract is created; for example, the information relating to the abstract is simply used to highlight the selected portions in the whole document or to hide the other portions of the document (so as to facilitate its scrolling and reading).

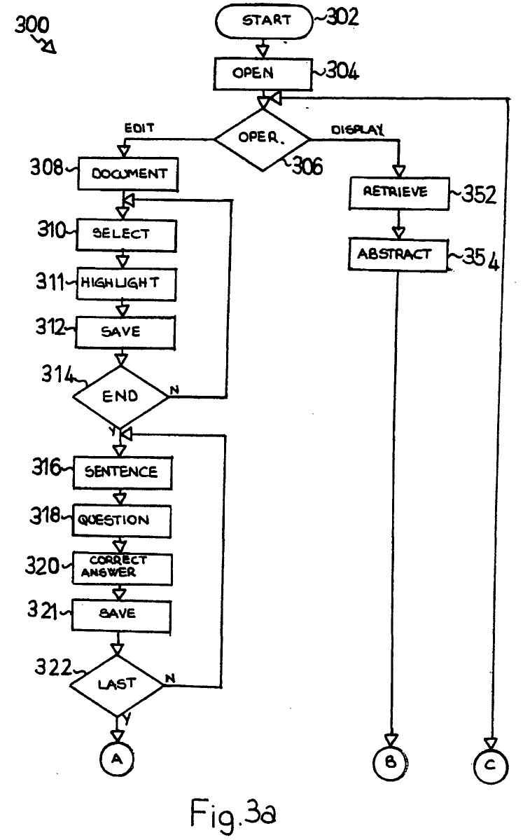

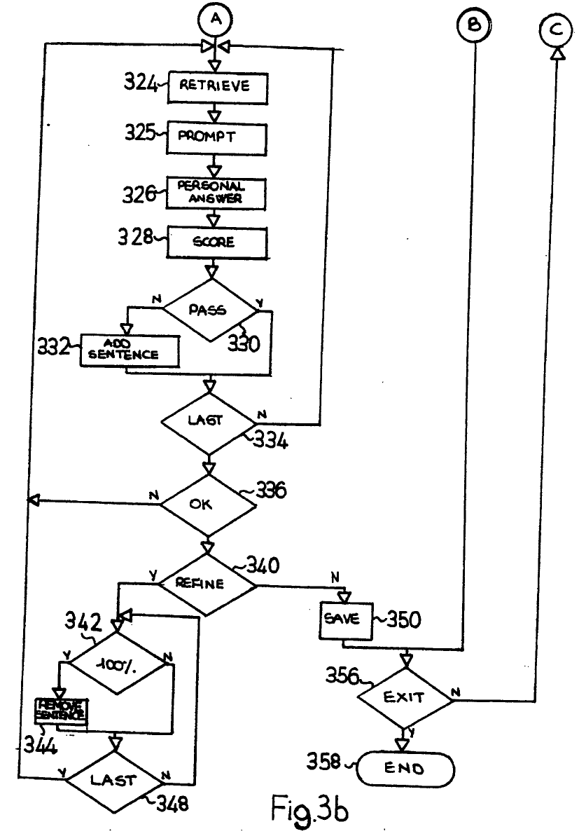

Moving to FIGS. 3a-3b, the above-described system implements a method 300 that begins at block 302. Proceeding to block 304, the user selects and then opens a desired document.

The flow of activities branches at block 306 according to an operation selected by the user. Particularly, if the user has selected an edit function the blocks 308-350 are executed, whereas if the user has selected a display function the blocks 352-354 are executed. In both cases, the method merges again at block 356.

Considering now blocks 308-350 (edit function), the whole document is displayed at block 308. Descending into block 310, the user can select a desired portion of the document. For this purpose, the user positions a pointer at the beginning of the portion, and then drags the pointer over the whole portion (holding a button of the mouse while it is moved). The method continues to block 311, wherein the selected portion is highlighted on the monitor by displaying it in a different mode. The selected portion with the corresponding pointer to its location in the whole document is saved at block 312. A test is then made at block 314 to determine whether the user has terminated the selection of the relevant portions of the document. If not, the flow of activities returns to block 310 for allowing the user to select a further portion.

Conversely, once the user has completed the definition of the abstract the process descends into block 316; for each selected portion of the abstract (starting from the first one), one or more sentences are chosen. In a simple implementation, the first sentence of each selected portion is taken into account; the sentence consists of a meaningful linguistic unit (including one or more clauses), which ends with a suitable punctuation mark (such as a period or a semicolon). Proceeding to block 318, a question for the sentence is automatically generated; for example, the question is constructed extracting the subject and the verb from its first clause. The method continues to block 320, wherein a correct answer for the question is determined; for this purpose, the correct answer is set to the remaining part of the clause (i.e., its object). Passing to block 321, the question with its correct answer is saved into the corresponding repository. A test is then made at block 322 to determine whether the last selected portion has been processed. If not, the flow of activities returns to block 316 for generating the question and the correct answer for a next selected portion.

On the contrary, the method enters a loop at block 324; for each selected portion (starting from the first one), the corresponding question and correct answer are retrieved from the repository. The user is then prompted at block 325 to enter his/her personal answer to the question. In response thereto, the user answers the question at block 326. The process continues to block 328, wherein a score (indicative of the level of understanding of the selected portion) is calculated. For this purpose, the personal answer is compared with the correct answer; the score is set to the percentage of the words in the personal answer matching the content of the correct answer. The method verifies at block 330 whether the score is satisfactory. If the score is lower than a predefined threshold value defining a pass level (for example, 70%), the flow of activities descends into block 332. In this case, the selected portion is probably too short for a good understanding, and it is then expanded in an attempt to convey the required information to the user; for example, a (non-selected) sentence of the document directly preceding the selected portion is added. The method then continues to block 334; the same point is also reached from block 330 when the score exceeds the threshold value. A test is then made at block 330 to determine whether the last selected portion has been processed. If not, the flow of activities returns to block 324 for handling a next selected portion.

Once all the questions have been put to the user, the method descends into decision block 336. If the user desires to refine the abstract, the flow of activities returns to block 342 for repeating the operations described above; for example, this choice is suggested automatically when the mean value of all the scores is lower than the threshold value. Conversely, a test is made at block 340 to determine whether the user desires to further optimize the abstract. If so, a loop is entered at block 342; for each selected portion (starting from the first one), the method verifies whether the score of the corresponding personal answer reaches a further threshold value defining a complete understanding (for example, 100%). If so, the method at block 344 condenses the selected portion by removing information that could be unnecessary (for example, deleting its first sentence). The method then continues to block 348; the same point is also reached from block 342 directly when the score is lower than the further threshold value. A test is then made at block 348 to determine whether the last selected portion has been processed. If not, the flow of activities returns to block 342 for handling a next selected portion. Conversely, the method goes back to block 324 for repeating the verification of the new abstract (as described above).

Referring again to block 340, if the user accepts the abstract the flow of activities descends into block 350; the selected portions with the corresponding pointers are saved on the computer. The method then proceeds to block 356 (described in the following).

Considering now blocks 352-354 (display function), the content of the abstract is retrieved at block 352. Continuing to block 354, the abstract is displayed on the monitor. The method then proceeds to block 356.

A test is now made at block 356 to determine whether the user has selected an exit option. If not, the flow of activities returns to block 306 for processing a new command entered by the user. Conversely, the method ends at the final block 358.

For example, let us consider the following document:

“This paragraph illustrates the capability of a non-SNA application to communicate with a SNA application using the TCP/IP transport protocol. Since the first application does not have a native support for TCP/IP, one of the possible solutions is to use products that convert TCP/IP datagrams over SNA network and vice-versa. Host integration Server 2000 (HIS) enables applications using SNA protocols to send and receive information over IP networks. The process of building the unique transmission frame is opaque to the application. The data, in turn, is passed through the SNA architectural layers to the Host Integration Server 2000 that allows communication through the usual TCP/IP path control. The purpose of this document is to describe a real and tested environment. Of course, that does not mean that all the other possibilities based on different products, or based on different versions and releases of the products used in this scenario, do not work, but it simply means that we have tested the product on the configuration described in this document.”

The user has selected the underlined portions of the document; therefore, the following questions with the corresponding correct answers are generated:
1. the first application does not have ->a native support for TCP/IP
2. one of the possible solutions is ->to use products that convert TCP/IP datagrams over SNA network and vice-versa
3. Host integration Server 2000 (HIS) enables ->applications using SNA protocols to send and receive information over IP networks
4. The process of building the unique transmission frame is ->opaque to the application
   The user is then requested to enter his/her personal answers to those questions. For example, the personal answers provided by the user are:
1. enough memory space
2. to use products that convert TCP/IP datagrams over SNA network
3. applications using SNA protocols to send information over SNA networks
4. opaque to the application
   As a consequence, the rate for each personal answer is:
1=0%
2=83%
3=75%
4=100%
   In this situation, only the first rate is unsatisfactory; therefore, the first selected portion is expanded adding its proceeding sentence. Assuming now that during a next iteration of the process the user provides the correct answers to all the questions (and he/she does not desire to optimize the abstract), the following document will be stored:

“This paragraph illustrates the capability of a non-SNA application to communicate with a SNA application using the TCP/IP transport protocol. Since the first application does not have a native support for TCP/IP, solutions is to use products that convert TCP/IP datagrams over SNA network and vice-versa. Host integration Server 2000 (HIS) enables applications using SNA protocols to send and receive information over IP networks. The process of building the unique transmission frame is opaque to the application”.

Similar considerations apply if an equivalent method is executed or if additional functions are provided. However, the concepts of the present invention are also applicable when the portions of the documents are selected with an equivalent procedure, or when a different number of questions are generated for each selected portion (such as one per sentence); alternatively, the questions and the corresponding correct answers are structured in another way (for example, requesting the user to enter one or more missing words of the sentence). In different implementations of the invention the score of each personal answer is calculated with alternative algorithms (down to a simple logic parameter taking a value true for a completely right answer or a value false otherwise); moreover, the score is deemed satisfactory only when all the questions for the selected portions have been answered correctly, or when the mean value of the corresponding scores exceeds the threshold value. However, the proposed solution is also suitable to be implemented expanding the selected portions in a different way (such as adding two or more preceding sentences). Similar considerations apply to the optimization function; for example, the complete understanding is defined by a lower threshold value, or the selected portions are condensed in a different way (such as removing more sentences at the beginning of the selected portion, or removing both its first sentence and its last sentence).

More generally, the present invention proposes a method of abstracting an electronic document stored on a data processing system. The method starts with the step of selecting one or more portions of the document. At least one question with a corresponding correct answer relating to a content of the document is then generated. The method continues entering a personal answer to each question. Each personal answer is compared with the corresponding correct answer. As a consequence, the selected portions are updated according to a result of the comparison. The method ends storing an indication of the updated selected portions.

The devised solution combines the advantages of an automatic procedure with those of a human intervention.

Particularly, the proposed solution provides an interactive process, which mix up the reader knowledge with computer-assisted processing.

As a consequence, the method of the invention strongly facilitates the creation of the abstract of any document.

In this way, a high quality of the abstract is ensured (irrespective of the kind of document).

Moreover, the proposed technique allows creating abstracts that meet the personal requirements of different readers.

Particularly, the method of the invention can be used to assist the reader in the process of learning and memorizing the content of the document (even if other applications are not excluded).

The preferred embodiment of the invention described above offers further advantages.

Particularly, one or more specific questions are generated for each selected portion (which is then updated according to the corresponding score).

In this way, the process can be individually focused on the different portions of the document.

A suggested choice for generating each question with the corresponding correct answer is that of using different parts of a sentence in the selected portion.

The proposed method is very simple, but it has proven to be quite effective.

However, the present invention leads itself to be implemented even processing the abstract as a whole (for example, updating all the selected portions according to the mean value of the scores); alternatively, the questions and the corresponding answers are generated in a different way (for example, according to the non-selected part of the document).

Preferably, each selected portion is expanded in response to an unsatisfactory result of the corresponding comparison.

This allows enriching the content of the abstract with a step-by-step process.

As a further enhancement, the selected portion is updated adding one or more adjacent sentences.

The proposed algorithm provides excellent results in most practical situations.

A suggested choice is that of adding only the sentence directly preceding the selected portion.

This solution increases the informative content of the abstract without an undue waste of memory space.

A way to further improve the solution is to condense each selected portion in response to a satisfactory result of the corresponding comparison.

The proposed additional feature allows optimizing the content of the abstract (reducing its size at the minimum).

Alternatively, the selected portions are updated in a different way (for example, requesting the reader to decide the information to be added); moreover, the number of sentences to be added can be established dynamically according to the corresponding rate, or it is possible to add both preceding sentences and following sentences. In any case, the solution of the invention is also suitable to be put into practice combining the operations of adding or removing sentences into a single step of the method, of even without the possibility of condensing the abstract.

Advantageously, the solution according to the present invention is implemented with a computer program, which is provided as a corresponding product stored on a suitable medium. Alternatively, the program is pre-loaded onto the hard-disk, is sent to the computer through a network (typically the Internet), is broadcast, or more generally is provided in any other form directly loadable into the working memory of the computer. However, the method according to the present invention leads itself to be carried out even with a hardware structure (for example, integrated in a chip of semiconductor material), or with a combination of software and hardware.

Naturally, in order to satisfy local and specific requirements, a person skilled in the art may apply to the solution described above many modifications and alterations all of which, however, are included within the scope of protection of the invention as defined by the following claims

1-9. (canceled)

10. A method of abstracting an electronic document stored on a data processing system, the method including the steps of:
selecting at least one portion of the document,
generating at least one question with a corresponding correct answer relating to a content of the document,
entering a personal answer to each question,
comparing each personal answer with the corresponding correct answer,
updating the at least one selected portion according to a result of the comparison, and
storing an indication of the at least one updated selected portion.

11. The method according to claim 1, further including the steps of:
generating at least one question with the corresponding correct answer relating to each selected portion, and
updating each selected portion according to the result of the corresponding at least one comparison.

12. The method according to claim 2, wherein the step of generating the at least one question with the corresponding correct answer relating to each selected portion includes:
choosing a sentence of the selected portion for each question,
setting the question to a first part of the sentence, and
setting the correct answer to a second part of the sentence.

13. The method according to claim 2, wherein the step of updating each selected portion according to the result of the corresponding at least one comparison includes:
expanding the selected portion in response to an unsatisfactory result of the at least one comparison.

14. The method according to claim 4, wherein the step of expanding the selected portion in response to the unsatisfactory result of the at least one comparison includes:
adding at least one non-selected sentence of the document being adjacent to the selected portion.

15. The method according to claim 5, wherein the at least one non-selected sentence consists of a sentence directly preceding the selected portion.

16. The method according to claim 2, wherein the step of updating each selected portion according to the result of the corresponding at least one comparison includes:
condensing the selected portion in response to a satisfactory result of the at least one comparison.

17. A computer program directly loadable into a working memory of a data processing system for performing a method of abstracting an electronic document when the program is run on the system, the method including the steps of:
selecting at least one portion of the document,
generating at least one question with a corresponding correct answer relating to a content of the document,
entering a personal answer to each question,
comparing each personal answer with the corresponding correct answer,
updating the at least one selected portion according to a result of the comparison, and
storing an indication of the at least one updated selected portion.

18. A program product comprising a computer readable medium embodying a computer program, the program being directly loadable into a working memory of a data processing system for performing a method of abstracting an electronic document when the program is run on the system, wherein the method includes the steps of:
selecting at least one portion of the document,
generating at least one question with a corresponding correct answer relating to a content of the document,
entering a personal answer to each question,
comparing each personal answer with the corresponding correct answer,
updating the at least one selected portion according to a result of the comparison, and
storing an indication of the at least one updated selected portion.

19. A system for abstracting an electronic document stored on a data processing system, the system including means for selecting at least one portion of the document, means for generating at least one question with a corresponding correct answer relating to a content of the document, means for entering a personal answer to each question, means for comparing each personal answer with the corresponding correct answer, means for updating the at least one selected portion according to a result of the comparison, and means for storing an indication of the at least one updated selected portion.

20. A system for abstracting an electronic document stored on a data processing system, the system including a pointing device for selecting at least one portion of the document, an engine for generating at least one question with a corresponding correct answer relating to a content of the document, an input device for entering a personal answer to each question, a comparator for comparing each personal answer with the corresponding correct answer and for updating the at least one selected portion according to a result of the comparison, and a memory for storing an indication of the at least one updated selected portion.
